(19) United States
(12) Patent Application Publication
(10) Pub. No.: US 2016/0004243 A1
(43) Pub. Date: Jan. 7, 2016

(54) METHODS AND APPARATUS TO SUPPORT FABRICATORS WITH COGNITIVE COMPUTING

(71) Applicant: Frederick A. Flitsch, New Windsor, NY (US)

(72) Inventor: Frederick A. Flitsch, New Windsor, NY (US)

(21) Appl. No.: 14/852,239

(22) Filed: Sep. 11, 2015

Related U.S. Application Data
(63) Continuation-in-part of application No. 14/689,980, filed on Apr. 17, 2015.
Application No. 14/689,980 is a continuation-in-part of application No. 13/398,371, filed on Feb. 16, 2012, now Pat. No. 9,059,227.
Application No. 13/398,371 is a continuation-in-part of application No. 11/980,850, filed on Oct. 31, 2007.
Application No. 11/980,850 is a division of application No. 11/156,205, filed on Jun. 18, 2005, now Pat. No. 7,513,822.
Application No. 13/398,371 is a continuation-in-part of application No. 11/520,975, filed on Sep. 14, 2006, now Pat. No. 8,229,585.
Application No. 11/520,975 is a continuation-in-part of application No. 11/502,689, filed on Aug. 12, 2006.
(60) Provisional application No. 62/049,360, filed on Sep. 12, 2014.
(60) Provisional application No. 60/595,935, filed on Aug. 18, 2005.
(60) Provisional application No. 60/596,035, filed on Aug. 25, 2005.
(60) Provisional application No. 60/596,053, filed on Aug. 26, 2005.
(60) Provisional application No. 60/596,099, filed on Aug. 31, 2005.
(60) Provisional application No. 60/596,173, filed on Sep. 6, 2005.
(60) Provisional application No. 60/596,343, filed on Sep. 18, 2005.

(51) Int. Cl. G05B 19/19; G05B 19/402

(52) U.S. Cl. CPC G05B 19/19; G05B 19/402; G05B 2219/31269; G05B 2219/50253

(57) ABSTRACT

The present invention provides various aspects of support for a fabrication facility capable of routine placement and replacement of processing tools in at least a vertical dimension relative to each other. The support aspect may include a cognitive computing system.

### CROSS REFERENCE TO RELATED MATTERS

This application claims priority to the United States Provisional patent applications bearing the Ser. No. 62/049,360, filed Sep. 12, 2014 and entitled “Methods and Apparatus to Support Fabricators with Cognitive Computing.” This application is a continuation in part of the Utility application Ser. No. 14/689,980, filed Apr. 17, 2015 and entitled: “Method and Apparatus for Vertically Orienting Substrate Processing Tools in a Cleanspace.” The application Ser. No. 14/689,980 in turn is a continuation in part of the Utility application, Ser. No. 13/398,371, filed Feb. 16, 2012 now U.S. Pat. No. 9,059,227, issued Jun. 16, 2015 and entitled: “Method and Apparatus for Vertically Orienting Substrate Processing Tools in a Cleanspace.” The application Ser. No. 13/398,371 in turn is a continuation in part of the Utility application Ser. No. 11/980,850, filed Oct. 31, 2007 and entitled: “Method and Apparatus for a Cleanspace Fabricator.” The application Ser. No. 11/980,850 in turn is a Division of the Utility application Ser. No. 11/156,205, filed Jun. 18, 2005 now U.S. Pat. No. 7,513,822, issued Apr. 7, 2009 and entitled: “Method and Apparatus for a Cleanspace Fabricator.” The application Ser. No. 13/398,371 in turn is a continuation in part of the Utility application Ser. No. 11/520,975, filed Sep. 14, 2006 now U.S. Pat. No. 8,229,585, issued Jul. 24, 2012 and entitled: “Method and Apparatus for Vertically Orienting Substrate Processing Tools in a Cleanspace.” This application is a continuation in part of the U.S. patent application Ser. No. 11/502,689, filed Aug. 12, 2006 and entitled: “Method and Apparatus to support a Cleanspace Fabricator” as a continuation in part application. The U.S. patent application Ser. No. 11/502,689 in turn claims priority to the following Provisional applications: Provisional Application, Ser. No. 60/596,343, filed Sep. 18, 2005 and entitled: “Specialized Methods for Substrate Processing for a Clean Space Where Processing Tools are Vertically Oriented”; and also Provisional Application, Ser. No. 60/596,173, filed Sep. 6, 2005 and entitled: “Method and Apparatus for Substrate Handling for a Clean Space Where Processing Tools are Reversibly Removable”; and also Provisional Application, Ser. No. 60/596,099, filed Aug. 31, 2005 and entitled: “Method and Apparatus for a Single Substrate Carrier For Semiconductor Processing”; and also Provisional Application, Ser. No. 60/596,053 filed Aug. 26, 2005 and entitled: “Method and Apparatus for an Elevator System for Tooling and Personnel for a Multilevel Cleanspace/Fabricator”; and also Provisional Application, Ser. No. 60/596,035 filed Aug. 25, 2005 and entitled: “Method and Apparatus for a Tool Chassis Support System for Simplified, Integrated and Reversible Installation of Process Tooling”; and also Provisional Application, Ser. No. 60/595,935 filed Aug. 18, 2005, and entitled: “Method and Apparatus for the Integrated, Flexible and Easily Reversible Connection of Utilities, Chemicals and Gasses to Process Tooling.” The contents of these heretofore mentioned applications are relied upon and hereby incorporated by reference.

### FIELD OF THE INVENTION

The present invention relates to apparatus and methods which support fabricators, fabricator systems and fabricator applications with cognitive computing solutions.

### BACKGROUND OF THE INVENTION

A known approach to cleanspace-assisted fabrication of materials such as semi-conductor substrates is to assemble a manufacturing facility as a “cleanroom.” In such cleanrooms, processing tools are arranged to provide aisle space for human operators or automation equipment. Exemplary cleanroom design is described in: “Cleanroom Design, Second Edition,” edited by W. Whyte, published by John Wiley & Sons, 1999, ISBN 0-471-94204-9, (herein after referred to as “the Whyte text”).

Cleanroom design has evolved over time to include locating processing stations within clean hoods. Vertical unidirectional air flow can be directed through a raised floor, with separate cores for the tools and aisles. It is also known to have specialized mini-environments which surround only a processing tool for added space cleanliness. Another known approach includes the “ballroom” approach, wherein tools, operators and automation all reside in the same cleanroom. Cleanspace fabricators represent a design type that offers improvement over standard cleanroom design.

There are also many other types of fabrication of high technology products that have similar characteristics and needs. Across these industries it would be desirable to have a similar tool structure and fabricator design that would allow for efficient production of small volume to large volume amounts of products with small production tooling. The high number of such small tools along with the high technology aspects of the production create needs for sophisticated control formalisms that can control large nodes of information with complex and varied production flows that generate situations of ambiguity and uncertainty.

### SUMMARY OF THE INVENTION

Accordingly, the present invention provides a novel design for processing fabs which arrange a clean room to allow processing tools to reside in both vertical and horizontal dimensions relative to each other and in some examples with their tool bodies outside of, or on the periphery of, a clean space of the fabricator. In such a design, the tool bodies can be removed and replaced with much greater ease than is the standard case. The design also anticipates the automated transfer of substrates inside a clean space from a tool port of one tool to another. The substrates can reside inside specialized carriers designed to carry ones substrate at a time. Further design enhancements can entail the use of automated equipment to carry and support the tool body movement into and out of the fab environment. Collections of large numbers of tools oriented in these manners as well as combinations of fabricators of all size create an ideal situation for a control formalism with cognitive computing solutions. As well, there may be numerous processes related to the development of new products of high technology where cognitive computing solutions may aid in the control of the fabricator solutions but also in the diagnosis and pattern recognition of factors of fabrication related to product results and needs out of products.

One general aspect includes a method of producing products; said method including: fixing two or more processing tools into position in a fab where the two or more processing tools at least a vertical dimension relative to each other, where the two or more processing tools are peripherally located with respect to a fab workproduct transportation region including a first boundary and a second boundary, and where each of the processing tools is capable of independent operation, and where each of the processing tools is removable in an unobstructed fashion relative to other processing tools. The method may then include connecting the fab and the two or more processing tools to a cognitive computing system and transmitting a digital signal to the cognitive computing system indicating the connection of the cognitive computing system to the fab and the two or more processing tools. The method may then include removing a workproduct from a workproduct carrier into a first tool port and transmitting to a cognitive node or computer that it has been removed. The method may then include performing a first process on the workproduct in the first tool. The method may then include containing the workproduct in the workproduct carrier subsequent to the performance of the first process. The method may then include transporting the workproduct carrier to a second tool port within the fab workproduct transportation region. The method may then include exchanging a sensor information and a logistic information from the second tool to the cognitive computing system. The method may then include removing the workproduct from the workproduct carrier into the second tool port; and performing a second process on the workproduct in the second tool. The order of various method steps may be varied and method steps may be added, moved, repeated or removed.

Implementations may include one or more of the following features. The method may include examples where the workproduct is or results in a mobile electronic device, an internet of things device, a living tissue or organ, a microfluidic device, an energy device, a light emitting diode, a pharmaceutical, an organ chip, or an integrated circuit. In some examples, the method may in examples where the processing includes a 3D printing operation or a microfluidic processing step in a microfluidic device as non-limiting examples. In some examples the method may involve the step where the communication protocol involves a query answer, or a protocol relating to query answer, or a sequential Markov decision process, or rule elicitation, or sensitivity analysis, or objective identification, or fact checking.

One general aspect includes a fab or product fabricator including a support structure for fixing in place two or more workproduct processing tools into position in at least a vertical dimension relative to each other, where the two or more workproduct processing tools are peripherally located with respect to a fabricator workproduct transportation region including a first boundary and a second boundary, and where each of the processing tools is capable of independent operation and removable in a discrete fashion relative to other processing tools; connections for connecting facility lines to each of the two or more workproduct processing tools. The fab may also include robotic automation for transporting work product between the two or more workproduct processing tools. In some examples, the workproduct transportation region or zone may be a cleanspace as in the examples of a cleanspace fab, in other examples the workproduct transportation region or zone may not be kept clean but in other ways maintain the design elements of cleanspace fabricator examples.

### BRIEF DESCRIPTION OF THE DRAWINGS

The accompanying drawings, that are incorporated in and constitute a part of this specification, illustrate several examples of the invention and, together with the description, serve to explain the principles of the invention:

FIG. 1 illustrates an embodiment of a vertical fab showing a reversibly removable tool body.

FIG. 2 illustrates a back view of a vertical fab embodiment where the fabricator cleanspace walls are see through for illustration of how handling automation can function.

FIG. 3 illustrates a front view of a fab embodiment with many exemplary tool types indicated.

FIG. 4 illustrates a back view of the fab embodiment of FIG. 3 showing the automation robotics.

FIG. 5 illustrates a flow sheet diagram of an example movement of a substrate by automation to processing tools indicated in a shown process flow.

FIG. 6 illustrates a flow sheet diagram of an embodiment of the interaction of automation and electronics systems operant in a fab embodiment of the type in FIG. 1.

FIG. 7 illustrates a flow sheet diagram of a demonstration of how an intellectual property fab automation system can interact with a fabricator automation system.

FIG. 8 illustrates a flow sheet diagram of a patent documentation system based on information contained in fabricator automation control systems.

FIG. 9 illustrates an example of a reversibly removable tool body being replaced in an example fabricator embodiment.

FIG. 10 illustrates flow sheet diagram of an example of how a small substrate can be cut out of a larger substrate in order to be further processed in a fabricator of the types in this patent.

FIG. 11 illustrates an example of how a substrate in a substrate carrier can be processed in more than one fabricator of the type in this patent; being transported between said fabs in a carrier.

FIG. 12 illustrates an organizational diagram for a fabricator with support of a cognitive computing solution.

FIG. 13 illustrates various flows of information, data and cognitive results amongst a fabricator and a processing entity capable of implementing or cooperating in a cognitive computing solution.

FIG. 13B illustrates a flow sheet diagram of a cognitive computing solution interacting with fabricators of great size.

FIG. 13C illustrates a complex cognitive computing systems with numerous distributed cognitive nodes including cognitive nodes with cognitive processors including electrical neurons, electrical synapses and complex data links.

FIG. 14 illustrates a flow sheet diagram of a process overview of research and development protocols for pharmaceutical products involving cognitive computing and linked enabled fabricators.

FIG. 15 illustrates a flow sheet diagram of an overview of processing biomedical devices in formalisms that utilize cognitive computing and novel fabricator types innately linked to cognitive computing solutions.

FIG. 16 illustrates a flow sheet diagram of processing formalism for creating human organs utilizing cognitive computing linked fabricators, medical imaging systems and novel 3d printing environments.

FIG. 17 illustrates a flow sheet diagram of processing formalism for creating novel, prototypical or customized devices for the mobile space, the internet of things and with 3d Printing; utilizing novel fabricating designs that are innately liked to cognitive computing systems.

FIG. 18 illustrates the high level processing aspects, connections and architectural aspects of innately connected cognitive factories.

### DETAILED DESCRIPTION

The present disclosure relates to methods and apparatus which enable the positioning of processing tools in a fab in both vertical and horizontal dimensions. According to the present invention, a portion of a tool used to process a material is accessible from within a cleanspace in which the material is processed and an additional portion of the processing tool remains outside of the cleanspace environment in which the material is processed. In addition, the present invention provides for methods and apparatus to facilitate installation, removal and maintenance of the tools used to process the material. Fabricators designed in this manner may have numerous advantages including the ability of supporting collections of small processing tools in efficient manners. Small volume fabrication may be scaled to large volume fabrication and each volume may be efficiently supported. In some examples, extremely large numbers of tools may create highly complex processing environments. Each of the tools may be thought of as a cognitive node providing their own sensing and operational data as well as receiving control directives and information as well. A cognitive computing system may enable such a structure to function.

In other examples, the small tool small volume solutions may be highly efficient solutions for research and development solutions. These factories too may be considered cognitive factories where cognitive computing systems provide advanced control protocols to record operating conditions, diagnose fault conditions and suboptimal operating conditions. As well, the cognitive factory may respond outwardly to users, customers, external datasets, market trends, models of product performance and the like. In the next sections a description of some of the aspects of a factory design type that may be innately tied to cognitive computing systems will be described and then followed with discussion on this exemplary fabricator and how when tied to cognitive computing systems novel solutions may be formed.

Reference will now be made in detail to different aspects of some preferred examples of the invention, examples of which are illustrated in the accompanying drawings. Wherever possible, the same reference numbers will be used throughout the drawings to refer to the same or like parts. A Glossary of Selected Terms is included at the end of this Detailed Description.

Although fabricators may be configured to process substrates, vessels and combinations of substrates and vessels in some examples, examples may be drawn upon substrate processing for illustration. During processing of semiconductor substrates, the substrates (sometimes referred to as “wafers”) can be present in a manufacturing fabricator for many hours. In some examples, wafers are contained within a carrier and a self-contained environment during the entire period that the substrates are not inside a processing tool. A tool port can receive such carriers and open them to position the substrates for further processing by the processing tools.

According to the present invention, tools are placed in a vertical dimension and a clean space is arranged such that one or more tool bodies reside on the periphery of the fabricator space. This allows the tools to be placed and removed in a much more straightforward approach when compared to typical clean room designs.

Traditionally, when installing a processing tool into a semiconductor fabricator, riggers had to place the tool in a designated position where the tool remained in place for its entire time in the fab. The present invention provides for an alternative strategy wherein processing tools can be routinely placed and removed from a fab location.

One aspect of the present invention therefore provides for support fixtures which facilitate efficient placement, removal and replacement of a processing tool in a predefined location defined in a matrix of vertical and horizontal dimensions. Predefined tool placement in turn facilitates predefined locations for utility interconnections and predefined locations for material transfer into and out of associated tool ports. In some examples, a support fixture can further provide a chassis capable of receiving a processing tool and moving a processing tool from a position external to a cleanspace to an operational location wherein at least an associated processing tool port is located inside the cleanspace environment. In some respects, movement of the tool from an installation position to an operational position can be envisioned much like a cabinet drawer moving from an outward position to a closed position.

Other aspects of some examples of the present invention include the connection of support items for proper operation of the processing tool. For example, electrical supplies, chemicals, gases, compressed air or other processing tool support can be passed through the tool chassis support system via flexible connections. Furthermore, wired or wireless transfer of data can be supported by the chassis body. In addition, in some examples, a support chassis according to the present invention can include communication interfaces with safety systems to provide safe operation and safe removal and replacement.

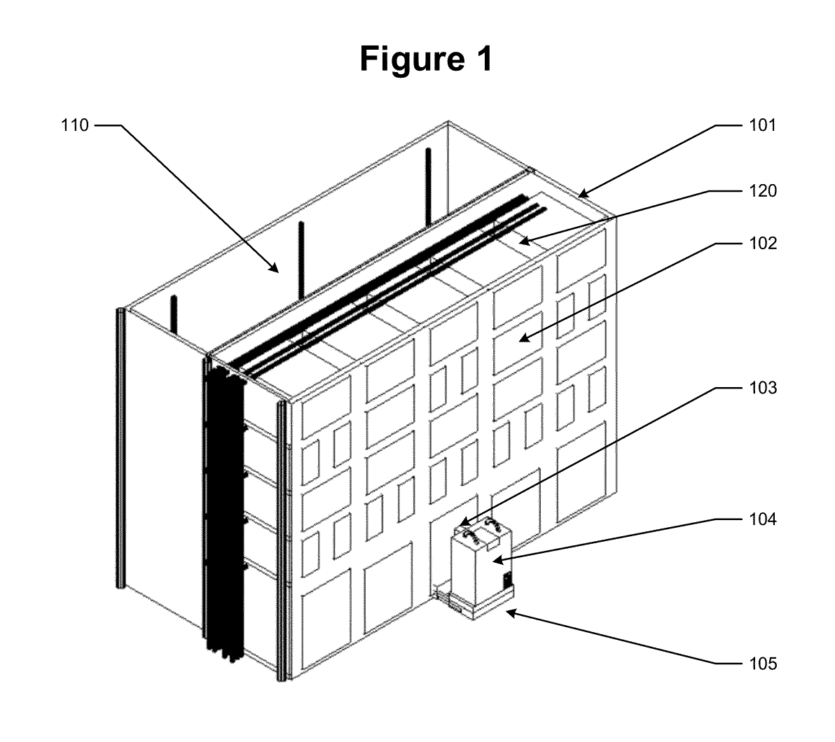

Referring now to FIG. 1 a fabricator 101 is illustrated from a tool access side, with exemplary processing tools, where one processing tool 102 is given a reference number, are presented in the fabricator environment. As illustrated, an array of various processing tools can include some processing tools situated above others in the vertical dimension. A tool port 103 is capable of receiving a substrate carrier (not shown) into the processing tool 102. A tool body 104 in a position for placement or replacement is also illustrated. This tool body can be situated on a tool chassis 105 for locating the tool body into a correct position. In a correct position, the tool body is situated to perform a process on the substrate introduced to the processing tool 102. In the fabricator 101, may be found an exemplary primary cleanspace identified as item 110 and also an exemplary secondary cleanspace identified as item 120.

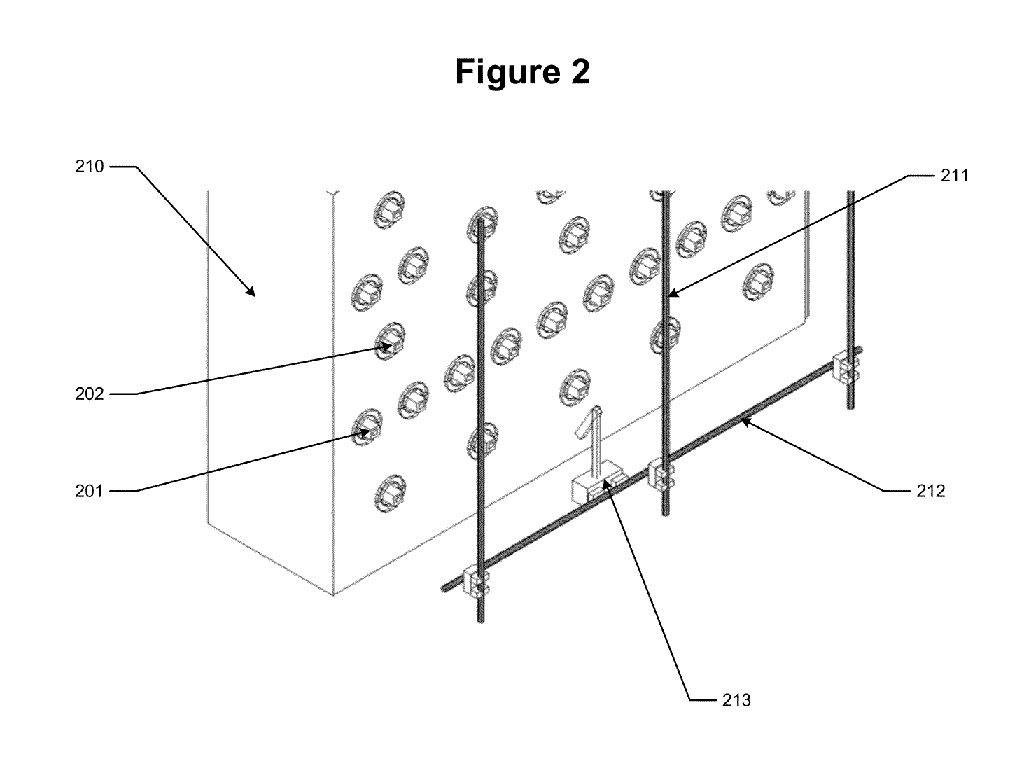

Referring now to FIG. 2, a view of a fabricator 210 is shown illustrating a side for introducing a substrate to one or more ports on a processing tool 102, wherein the processing tools are arranged in a horizontal and vertical matrix. By making the clean space walls transparent, the operation of an embodiment of fabricator automation can be shown. Item 211 illustrates a vertical rails the robotics can ride upon. A corresponding horizontal rail is shown as 212 and the robotic handler as 213. These robotics can move the carrier from tool to tool through the tool ports, for example from tool port shown as item 201 to tool port shown as item 202.

In some examples, a base fabricator design, with tools on the periphery and stacked in the vertical dimension can function as a fabrication environment or fab. Also, in some examples, a rapid thermal anneal tool can be capable of interfacing with an 8″ SMIF port to receive pods of 25 wafers at a time, wherein the SMIF automation is hard mounted to a fabricator support and gas line connections are welded in place.

A processing tool of one of various types can also be altered to allow the tool to be reversibly removable from a fabricator. This method specifically relates to altering the tool design to create a tool body that can interface with a locating chassis of some kind

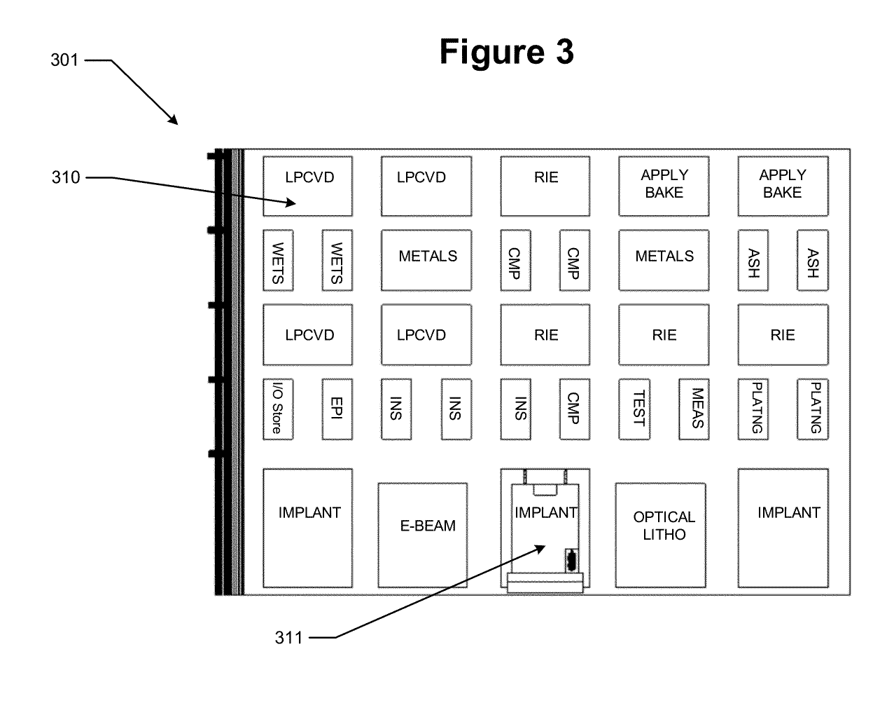

Referring now to FIG. 3 a schematic front view of a novel fabricator 301 is displayed. A fabricator 301 thus configured creates a novel processing environment in its own rights. However, to function the fabricator needs to be populated with processing tools that may perform standard processes used to make state of the art devices on the substrate surface. The process environment can include industry standard tools or tools that are specifically designed to be situated in a horizontal and vertical matrix, and, in some examples with multiple small clean spaces each clean space sufficient to encompass one tool port.

FIG. 3 depicts how standard processing tool types can be arrayed in a fabricator, 301, incorporating the novelty discussed herein. Each of the tools, such as, for example 310, can include on its face an indicator or other description of the tool type. Also for reference, tool 311, shows an example of a tool in the process of being replaced.

Each of the tool types in FIG. 3 can have been designed using the methods discussed previously. For example, LPCVD can refer to the common Low Pressure Chemical Vapor Deposition processing equipment. The typical state of the art materials and designs for a reactor of this type are still operant in this environment; however, it may be made consistent with single wafer processing. Processing the substrate on a susceptor with the reactants passing over the single wafer can be such a change. Furthermore, the tool can be redesigned to have its chemical gas lines routed through a single location where they can be easily connected and disconnected. The body of the tool, can be designed to sit on a base which itself can interface to the chassis that all tool bodies in a fab of this type can sit on. Input to the tooling can be made through the tool port which can involve redesigning the tool body's internal wafer handling systems to interface with this tool port and its location. These general methods are not used in a state of the art fabricator of a conventional design.

In much the same way all the tool types shown can be designed following this method. Examples can therefore include, for example, Reactive Ion Etch equipment shown in FIG. 3 and others as RIE. Photo Resist application tools which may have baking capability are illustrated as APPLY BAKE tools. Chemical processor focused on single wafer front side and backside chemical processing for etches and cleans are shown as WETS. Metal deposition equipment capable of depositing Aluminum, Titanium, Copper, and Gold to name a few example metals are show as METALS tools. Chemical Mechanical Polishing equipment are shown as CMP equipment. Photoresist and chemical plasma treatment tooling is shown as ASH tooling. Equipment designed to store carriers in a controlled manner and allow input and removal of the carriers from the fabricator to the outside environment are shown for example as I/O Store. Epitaxial deposition tooling is shown as EPI. Plasma enhanced CVD, Plasma reactive CVD or Physical Deposition of insulator films is shown as INS. Electrical probing equipment is shown as TEST. Physical measurement tooling is shown as MEAS. Chemical Plating tooling, for example for Copper plating, is shown as PLATING. Ion Implantation tooling is shown as IMPLANT. Lithographic tooling is shown either as E-BEAM if the image writing is done with an electron beam or OPTICAL LITHO if a laser or other optical light source is used to expose a masked image. These are some examples of tools that can be innovated from current designs using a method based on this new fabricator environment.

It may be noted that while the discussion has focused on tooling that has an already established industry presence and solution, this is not the only tool types that can use this method. In a more general sense, any processing tool even those to be developed can be designed to be consistent with this fabricator design using the method discussed. While this method does not fully result in a tool solution, it does allow the methods that do result in tooling solutions to be enhanced to allow that solution to work in this novel environment.

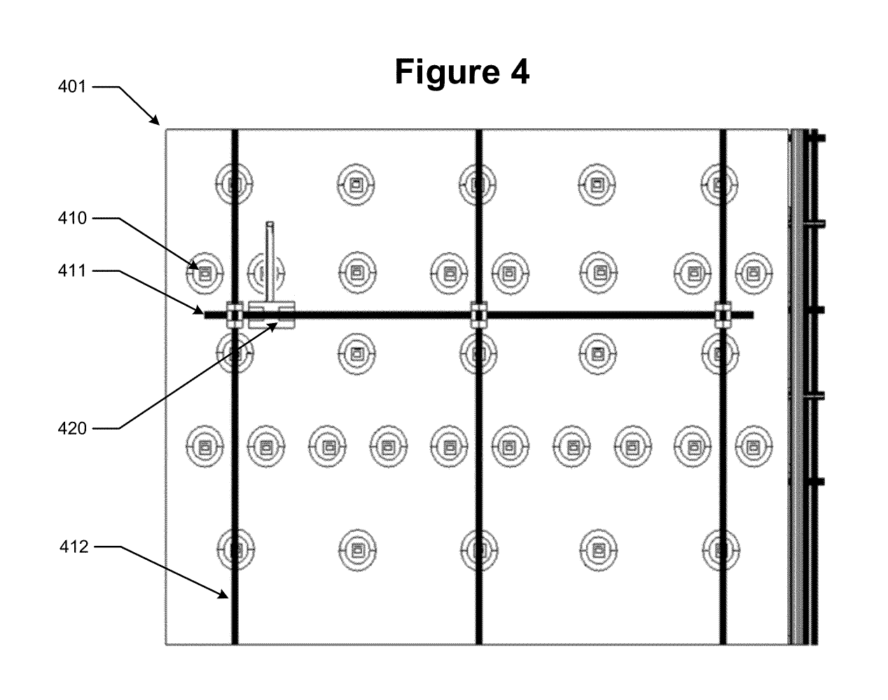

In the backside view of FIG. 4, aspects are illustrated indicating how the locations of the various tools in the fabricator environment 401 together with the ports 410 that are on each tool body. A substrate carrier can be handed off from a logistics robot, 420, to such a tool port, 410. The process can work by a tool of any type having already handed off a carrier to the robot 420. Robots 420 can move in one or more of a vertical direction along the rails of type 412 and along the horizontal dimension along rail 411 until it is situated at the appropriate location in front of a processing tool's port. In FIG. 4 the robot is shown to have moved in front of an ASH tool. The robot 420 can then place the carrier into the ash tool's port so that it can receive a process appropriate to that tool type.

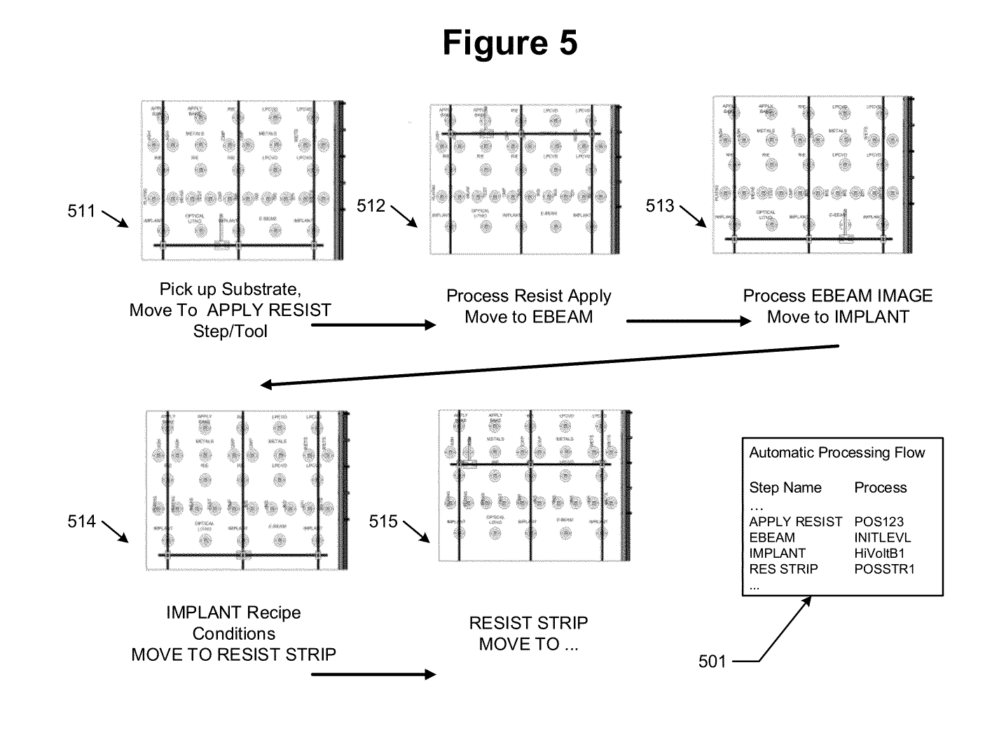

FIG. 5 takes the step forward by illustrating how a series of steps (items 511, 512, 513, 514, and 515 in an exemplary sense) can be performed by movements discussed above relating to FIG. 4. In item 501 a flow diagram in a written form, which can be electronically stored in a computing mechanism, can schematically represent the movement, and handoffs of the logistic robots to the tool ports of the various tooling. In such a manner, processing of substrates can be represented in software code. It is also important to note that by having such a process flow in an electronic computer, that the automation systems of the fabricator can be automatically directed on how to process a substrate. IN some examples, multiple substrates can be coincidentally processed in the fab environment with the computing mechanism directing the movement of each substrate from one tool port to another and also providing instructions to each processing tool 102 via data communication. The instruction can include, for example, a command to receive a substrate and to perform certain processes on the received substrate.

By directing a substrate to move in and out of numerous tools to receive numerous process steps in a much longer version of the processing example depicted in FIG. 5 devices of various types can be manufactured on the substrates. While the resulting devices may not differ in this method of manufacturing from a more typical one, it may be apparent that this method of manufacturing the device in how the process tools are arrayed in a clean space, in how the substrates are moved to those tools is novel in its own right.

This description has described the general case of how to make a device of a particular process type. It may be clear that the generality is anticipated to allow for novel ways of making devices of any type. Specific known types are specifically claimed for the novel aspects of this method in affecting a processing of substrates to manufacture the specific device type. Devices can be made for Complementary Metal Oxide Semiconductor devices CMOS, for MOS, for Bipolar, for BiCMOS, for Memory, for BIN, for Power, for Communication, for Analog, for Discrete, for Microcontrollers, for Microprocessors, for Microelectronic Machines (MEMS) and sensors, for Optical, for Bioelectronics devices. These specific device types should not limit the generality of any device type that can be built on a substrate being manufactured with the general method described herein.

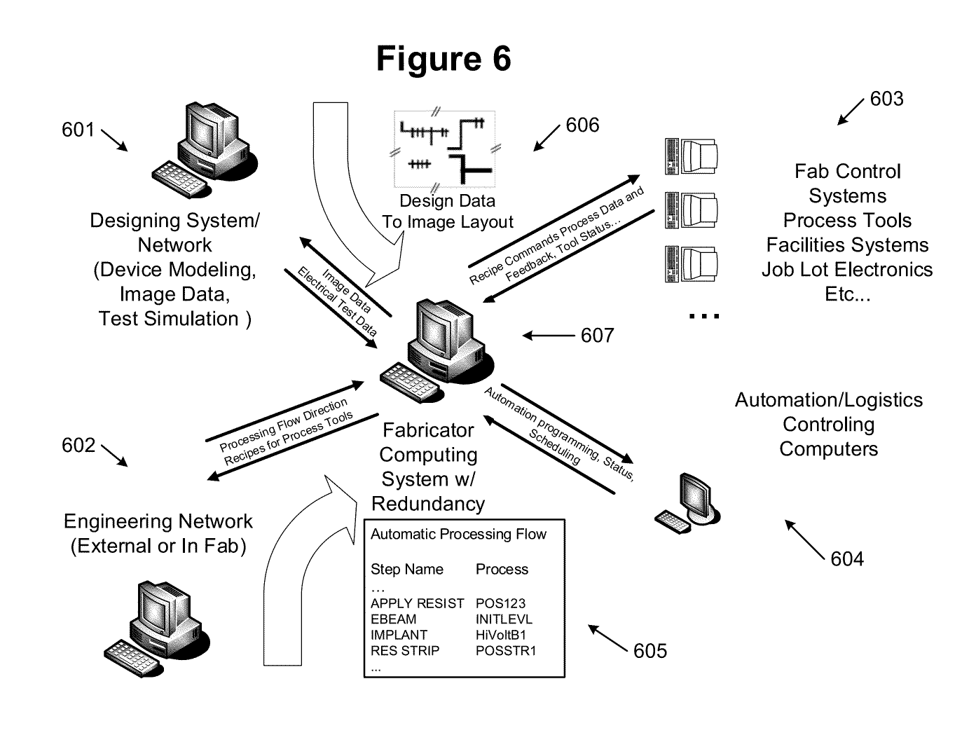

Referring now to FIG. 6 an illustration of how such automation can be set up in a fabricator type according to the present invention is illustrated. At 607, a fabricator computing system can have control over data communication extending within and outside of a fabricator. In some examples, the fabricator computing system 607 can interact with an external engineering system for the purpose of exchanging technical data, process data, flow data, imaging data for example to be passed on to Electron Beam equipment, for electrical test data and the like. The fabricator computing system 607 can also retain the substrate history logs for what processing has occurred in them and also what processing is specified to occur in the future. It can control the automation systems to move substrates via robotic automation associated with the fabricator and also to direct the processing tools on how to process and handle substrates that are given to it. Although a computer is shown for illustration, the sophistication of this main processing systems can be quite high with redundant processing units, significant data storage capabilities and significant communication capabilities over networks, radio frequency control and the like. Some examples therefore include a storage device which accesses a storage medium. The storage medium can include executable code and data for executable by a processor to control various aspects of the fabricator tools and the robotic automation.

According to the present invention, a fabricator computing system may interact with one or more of: a design system 601 for device modeling, imaging and test simulation; engineering systems 602 functional to create and administer processing flow directions and recipes for process tools; fab control systems 603 functional to control process tools, facilities systems and job lot electronics; automation and logistics controlling computers 604 for programming robotics automation, status of substrate movement and scheduling; and systems for creating and administering design data and image layout 606 as substrate processing occurs in an automated processing flow as may be represented by an exemplary flow depicted in item 605.

Control systems and handling mechanisms are therefore able to cause the fabricator to act on single substrates at a time. Examples can therefore include each substrate being processed in unique ways or predefined processes being repeated on individual substrates. Examples of the present invention can therefore be particularly well suited for the purposes of prototype or low volume manufacturing.

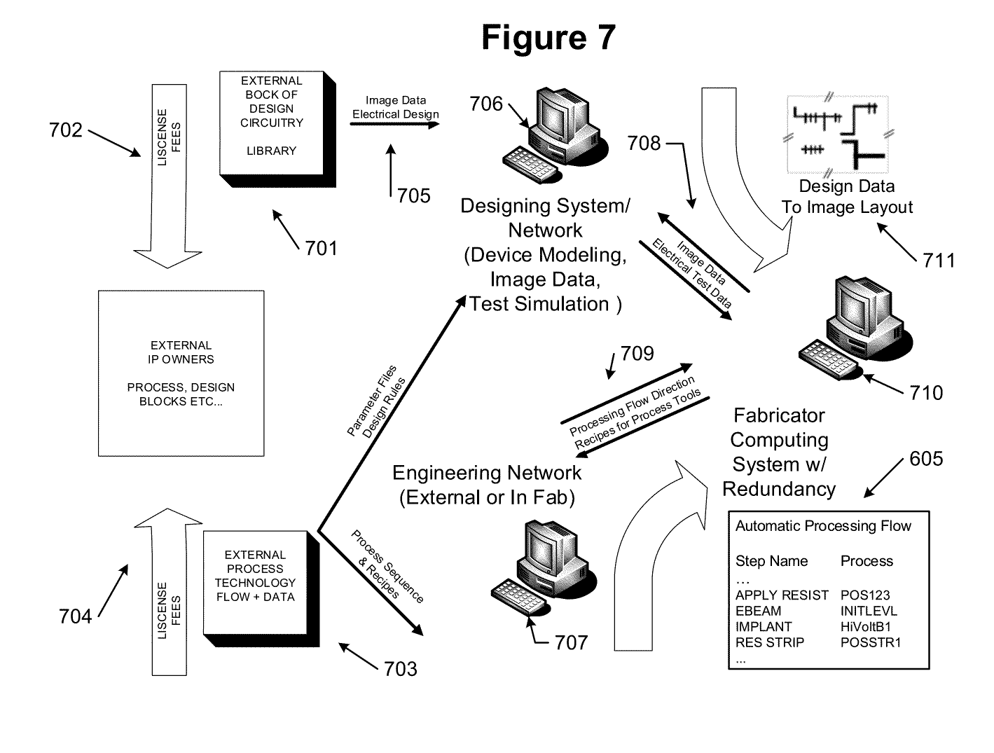

Referring now to FIG. 7, in some examples, design and control environments shown in FIG. 6 can also be enhanced such that design of a particular device can be represented by a number of functional blocks 701. With the unique ability to create a single small substrate, particularly when a lithograph utilized is a direct write operation, as for example, electron beam lithography, it can be plausible that a designer of a circuit can integrate predefined function blocks of various kinds into a design from an external source to create an image design as shown by item 705.

A fabricator environment can control processing of a submitted design while the designer can indicate both the process flow and the design data to process the substrate. In some embodiment a library of design blocks and process flows can be made available to a designer. The designer may indicate a series of predefined design blocks 703 to be utilized to create a new design in the aggregate and in the order specified by the designer. In some examples, a designer may request to use design blocks and processing flows that are the intellectual property of other entities, a licensing system 702 can track such usage and automatically apply license terms, license fees 704 and royalty type aspects for the use of either the design block or the process flow or both.

Parameter files and design rules 706 may be communicated with a design system network 706 and process sequences and recipes can be communicated with an engineering network 707. In some examples, one or more of the systems can be located external to the fabricator.

Examples can also include communication of image data 708 and processing flow directions and recipes for process tools 709 to and from a fabricator computing system 710. The fabricator computing system 710 can generate and store design data 711 for image layouts and automated processing flows. An automated process flow, can include, for example, a series of step names and processes.

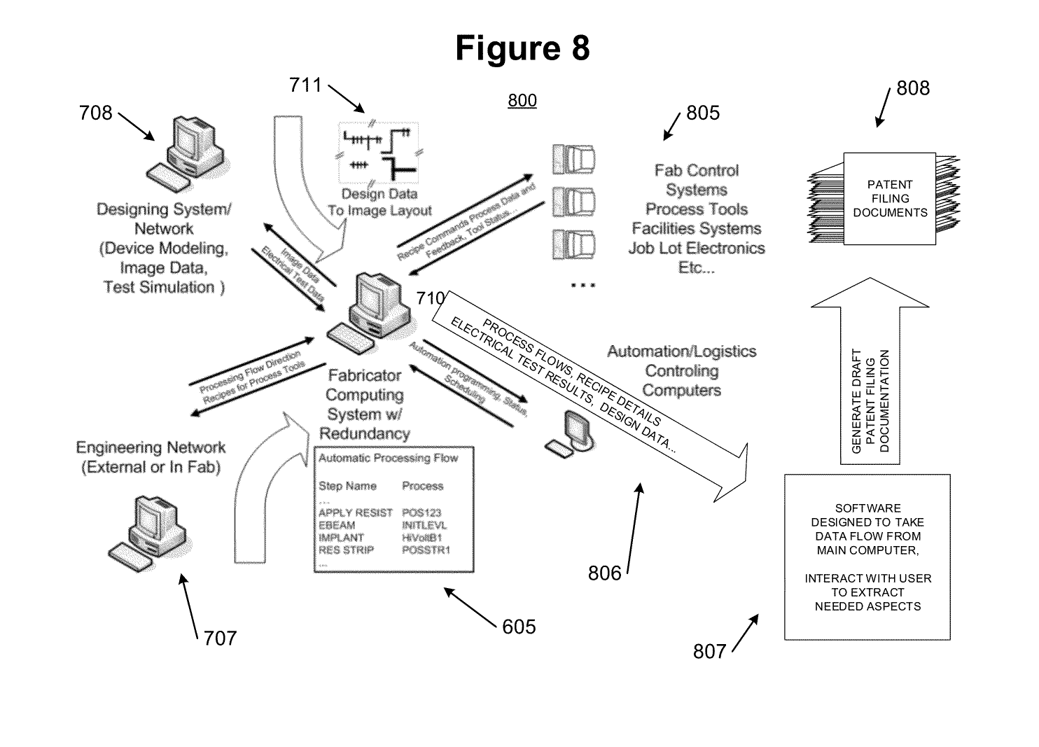

Referring now to FIG. 8, an exemplary license system architecture 800 is illustrated according to the present invention, wherein data retention capabilities of a main processing unit of a fabricator can be integrated into an intellectual property system 806 that automatically prepares intellectual property ownership documents. The licensing system can be operative via software to receive data flow from any of the fabricator components and extract data which can be compiled into intellectual property. The data can include, for example: process flows, process conditions, designs, duration of process steps, sequence of process steps and any other variables of process steps implemented by process tools and robotic automation included in a fabricator. Documents can include, for example, support for patent filing documents 808, copyrights or other similar concepts. According to the present invention, the license system architecture 800 can also be the manner that owners of particular intellectual property can license these particular properties to additional fabricator units of the type envisioned in this description. The licensing schemes can incorporate any of the variety of typical schemes including encryption or identification key tracking or the like; however, the use of such schemes for design flows and design data is new. It is also possible in some examples that fab control systems may track and record various information including for example the result of electrical measurements, physical measurements, logistics flow information and information of the like which may be depicted as item 805.

The data that is collected by the main computing systems also called the fabricator computing system, 710, may be processed and displayed to the user. The user may interact with the displayed information to extract relevant information as shown in the process step item 807. In some examples, this data may be an important input into the creation of the patent filing documents, 808.

Design aspects which may be stored in an electronic storage and accessed by a design system may include, by way of non-limiting example: CMOS type device flow; elements of a bipolar type device flow; elements of a memory type device flow; elements of a III/V type device flow; Microprocessor designs; Power Circuit designs; Communication designs; Analog designs; Discrete designs; Erasable Memory designs; T Microcontroller designs; MEMS designs; Optical designs; Bioelectronics designs; Chemical Mechanical Polishing processes; perform Electron Beam Lithography processes; Optical Lithography processes; Immersion Optical Lithography processes; Rapid Thermal Annealing or Reaction processes; Thermal Chemical Vapor Deposition; Chemical Vapor Deposition; Physical; and Vapor Deposition processes.

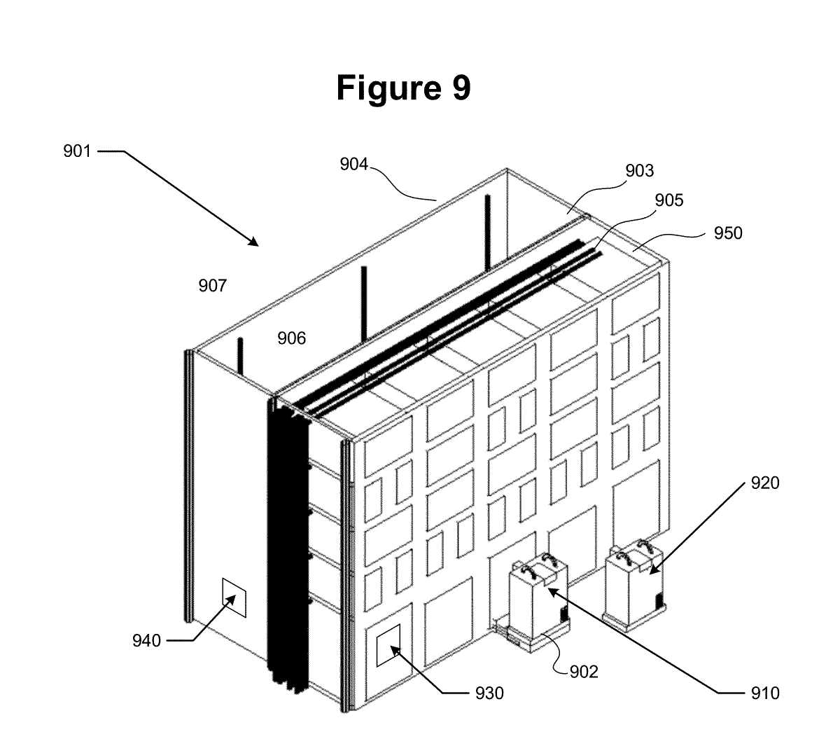

Referring now to FIG. 9, as has been mentioned, processing tools 910 in the fabricator according to the present invention can be easily replaced by access from a side other than the side used to receive a substrate. As can be seen in this diagram, a tool residing in the fabricator 901 that in FIG. 3 was indicated as an implant tool for its position can sit on a chassis 902 that can be extended from a position within a secondary cleanspace, 950, when the tool needs to be removed.

In an exemplary fashion, a first boundary 903 and a second boundary 904 may partially define a cleanspace by defining a region 906, which in some examples may be a primary cleanspace, with a different air particulate cleanliness than a second region 907, which may represent an external region that is external to both the primary cleanspace and the extents of all tools in the fabricator. In some examples, a flow of air may be present in the primary cleanspace. This flow may in some examples have the characteristics of laminar flow; in other examples, unidirectional flow and in other examples a flow characteristic that is different from laminar or unidirectional flow. From an exemplary sense, in FIG. 9, the air flow may proceed from boundary 903 to boundary 904 and in some cases the flow may originate from components upon the boundary of 903 or in other cases within or behind the boundary. The airflow in this example may proceed through an air receiving wall which may be represented by 904.

In some examples, an identical tool, 920, of the type as 910 can be in the vicinity so that when the facilities lines 905 of the tool 910 are disconnected; tool pod 920, can be moved onto the chassis, moved into the correct position in the fab and then have the facilities lines connected.

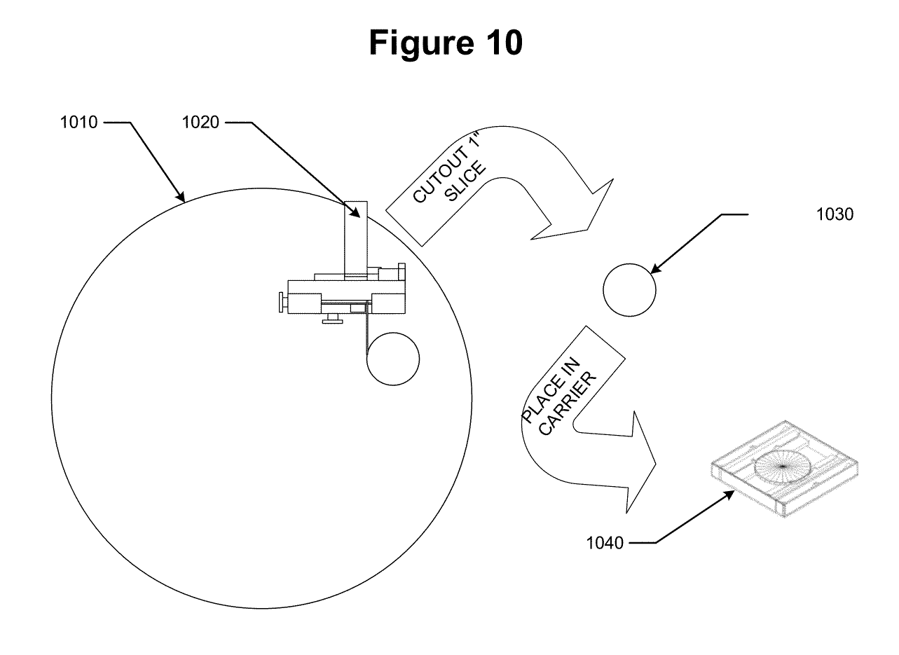

As also indicated in FIG. 9, there is a region shown for example as 907 which is external to the fabricator and the tools within the fabricator. In many examples, this region may not be a cleanspace. In some examples, a substrate carrier 1040, shown for example in FIG. 10, may be located in the external space, 907 and then be introduced into the fabricator. In some examples, the carrier may be introduced into the cleanspace from a receptacle located in a specialized type of tool, as shown by item 930. Alternatively, in some examples it may be possible to introduce the substrate carrier through a receptacle, 940 located at the periphery of the primary cleanspace or the fabricator cleanspace.

In other examples, a process tooling 910 can be include a disparate cleanspace pod which encloses all or part of the processing tool 910. For example, the cleanspace pod may only encompass a port portion of a processing tool and thereby be functional to receive a substrate into a cleanspace environment and process the substrate while it is maintained in a cleanspace environment. In other examples, a pod may fully contain a processing tool 910, such that during replacement of a processing tool in a horizontal and vertical matrix, a full cleanspace pod which includes a processing tool within it, is removed and a replacement cleanspace pod is inserted, wherein the replacement pod includes within it a replacement tool intact. In this fashion, processing tools may be removed for service or updates and shipped to a service destination while the processing tool remains contained within its own cleanspace pod. In addition, a support matrix for pods can be constructed in a warehouse type environment and cleanspace pods, each pod containing a process tool, may be arranged in the matrix to easily construct a cleanspace fabricator. In some examples, it is even feasible to arrange such a matrix in a mobile unit, such as, for example, in a tractor trailer type container, a ship, or temporary facility such as a military camp.

A different novel concept relating to the novel fab type can be the finishing of substrates that are generated as a cutout piece from an even larger substrate. Referring now to FIG. 10, for example, an eight inch substrate, 1010, can have a 1 inch substrate, 1030, cutout by a dicing tool 1020. Such tool can be a diamond saw type tool, a high pressure water jet tool, and a laser cutting tool or the like. Once the smaller substrate is prepared from the larger one, the smaller substrate 1030 can be placed in a wafer carrier 1040 and readied for further processing in the novel fabricator type. There can be numerous reasons that such an activity can be done for. For example, if a large volume fabricator wanted early yield information it can have a large wafer cut into a center piece and a few edge pieces and these can be prioritized through the novel fab in a similar process flow to provide testable devices in a very quick timeframe. Although an 8 inch wafer has been described in the given example, any size substrate can also be treated similarly.

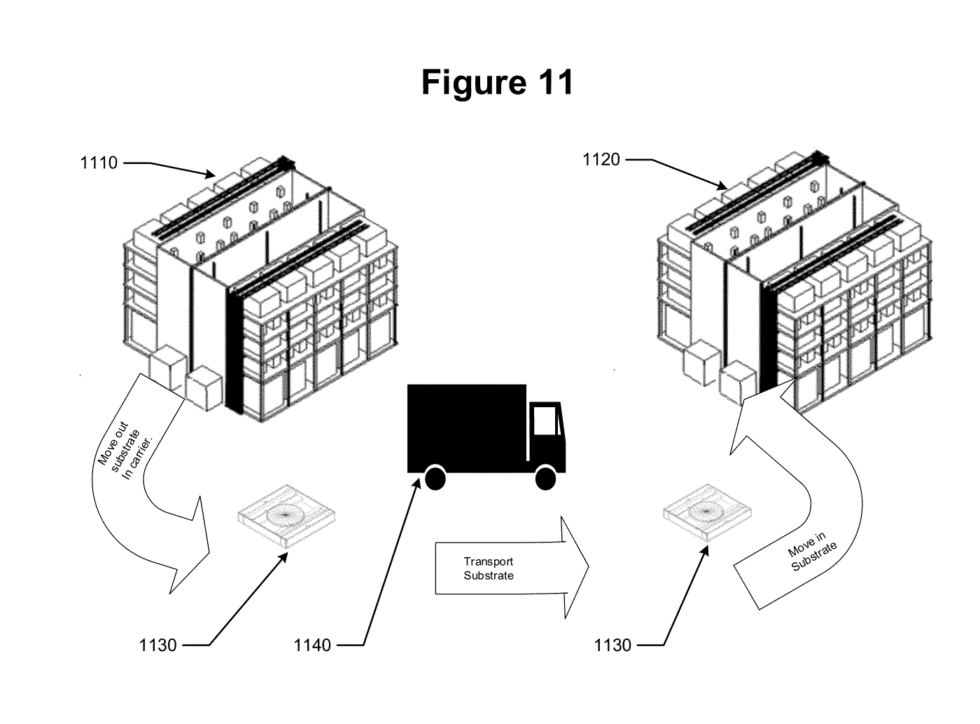

FIG. 11 shows another general concept. Since the substrates are stored in carriers that protect the substrate, such substrates can be processed different fabricators of the type described herein. The substrate can begin its processing in a fabricator of type 1110. After some level of processing it can be removed from said fabricator in a single substrate carrier, 1130, and then transported by some means 1140. When it arrived at another appropriate fabricator, the substrate can be replaced into the next fabricator of the type described herein, 1120, and processing can recommence. In this manner, in some examples, fabricators of different sizes and capabilities can be utilized to complete processing of a particular substrate.

Examples in the previous description have discussed the concepts of cleanspace fabricators for the examples of substrates. Cleanspace fabricators may more generally process work products; which in some examples may be located upon a substrate. It may be appropriate to view the fabricator as processing workproduct in a general sense.

Examples in the previous descriptions have discussed the concepts of cleanspace fabricators. There are cases where fabricators may be formed in analogous manners where the region that is used to transport workproduct from processing tool to processing tool is not a cleanspace. In these cases, the transport region may be referred to as a workproduct transfer region. In this sense there are some examples where the workproduct transfer region is a cleanspace and some where it is not.

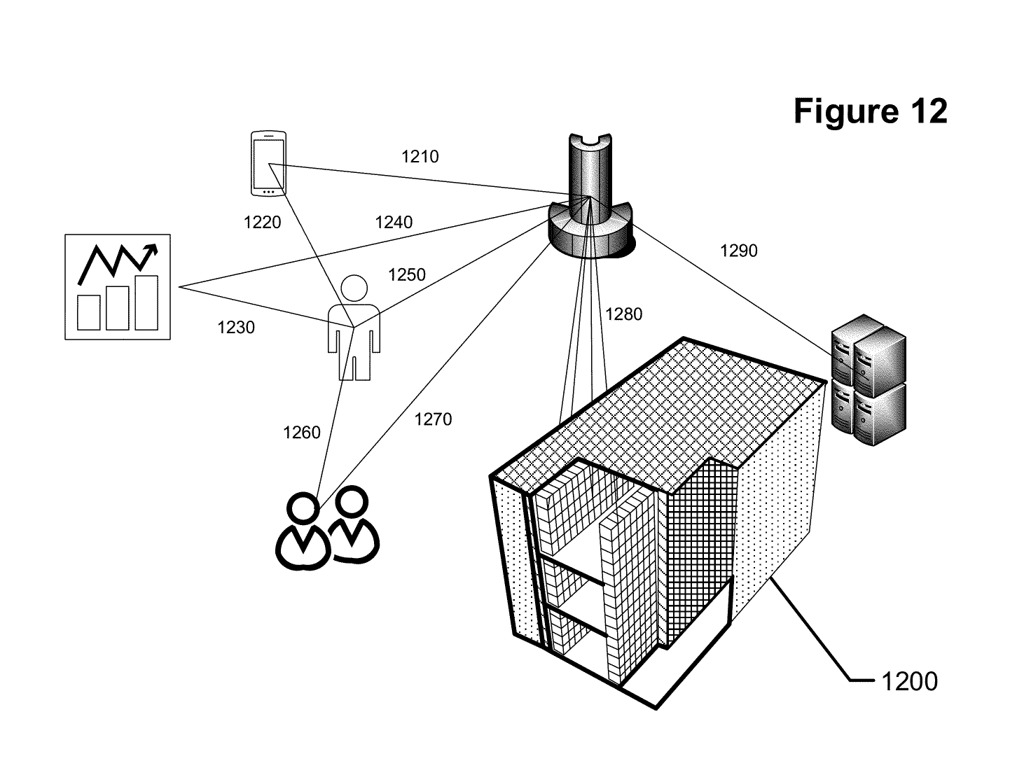

These aspects of an exemplary fabrication environment may form an exemplary base to describe a combination of a fabricator with a cognitive computing system. Referring to FIG. 12 an exemplary depiction of a cognitive factory may be found. A cognitive factory may be characterized as a factory with multiple automated tool nodes that have ability to flow information and data electronically to and from their nodes. The exemplary factory 1200 may have a couple hundred tools deployed for a production purpose, where the tools are small tools capable of easy reversible removability. The tools may interface with the fabricator through a tool pod and tool chassis formalism and data may be transmitted in a “hard wired” or connected manner or by wireless means. Various types of tools may be present and the tools may have various types of sensing along with individual data processing systems. In some advanced examples, the data processing systems may themselves consist or comprise cognitive processing hardware or chips. These individual nodes may communicate 1280 with a cognitive computing node.

In some examples, the fabricators will have collections of tools combined into separate cognitive nodes for control and processing and optimization. These separate cognitive nodes may communicate 1290 with a cognitive computing node for the fabricator system and environment. The cognitive nodes may include standard computing hardware that perform algorithms for cognitive processing. In other examples, some or all of the computing hardware may comprise alternative design topology such as in a non-limiting perspective neuromorphic parallel processors, cognitive synaptic computing circuits which may comprise electronic neurons, artificial neural networks or electronic circuits modelled on biological neurons.

There may be stakeholders such as employees, owners and the like that communicate 1250 with a cognitive computing node. There may be numerous types of communication relating to cognitive computing. In some examples, stakeholder may utilize question and answer formalisms to pose various queries to the cognitive nodes. In a non-limiting sense the questions may related to business aspects of operations, to financial aspects, to materials control aspects, to operational aspects, to product flow, to product quality, to delivery and order realization aspects, to technology aspects, to processing results, to product specification compliance and a host of other such aspects of the system. The stakeholders may themselves provide information of various kinds to the cognitive system.

There may be external parties that communicate 1260 with the stakeholders or with the cognitive node 1270. These parties may comprise a node in the cognitive system and interaction of various types similar to the stakeholder interactions or in some examples in supplementary manners.

There may be various data systems comprising financial, operational data and the like that are used to communicate at 1230 with stakeholders or may be directly accessed by the cognitive processing node. There may be various communication systems, including mobile based communication systems that communicate 1210 with the cognitive node and are in communication 1220 access with stakeholders. There may be numerous other nodes not depicted that are typical inputs into cognitive computing systems, but the identified nodes may form a good basis for understanding some of the basics of cognitive factories.

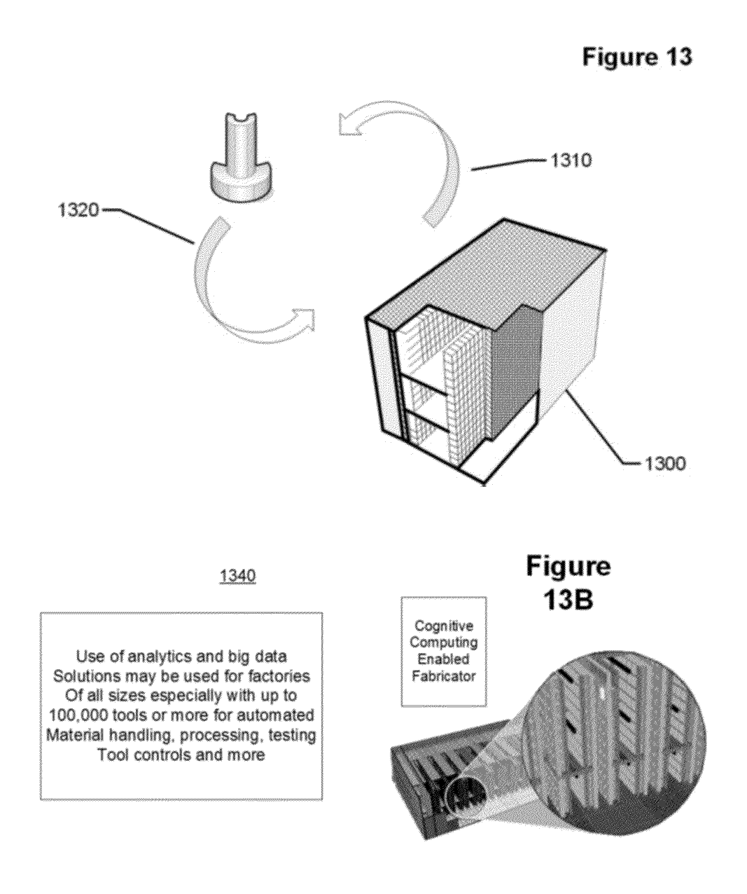

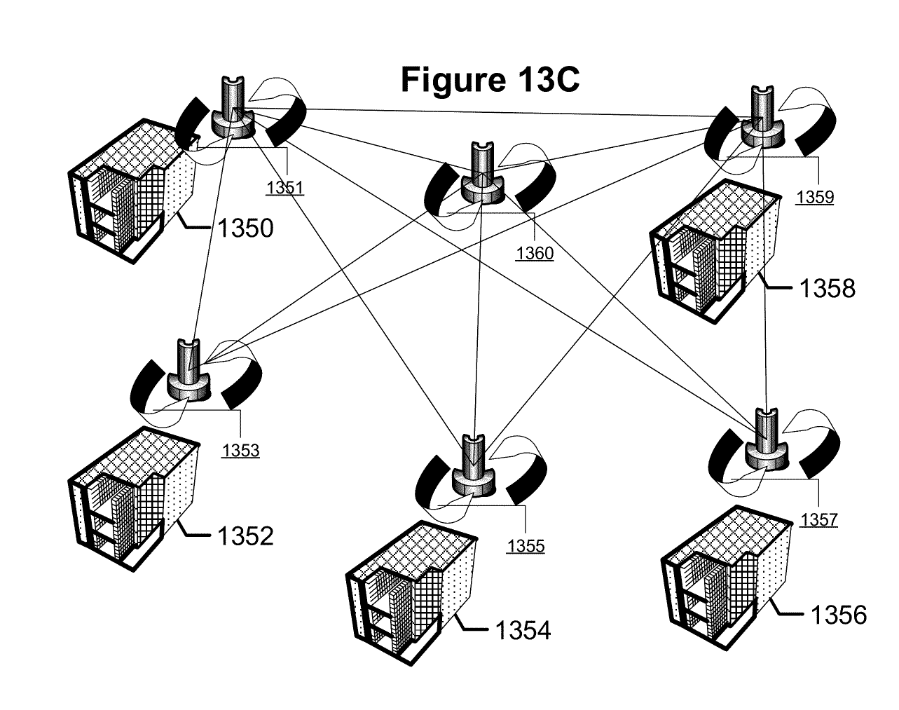

Referring to FIG. 13 there may be various follows of information, sensor output, data flows and the like from 1310 the factory 1300 to the cognitive processing node 1330 and to 1320 the factory 1300 from the cognitive processing node 1330.

Referring to FIG. 13B another depiction of a cognitive factory 1340 may be found. There may be the numerous external node interactions as have been described. However, the cleanspace factory design with vertically deployed small tools that are peripherally located and are connected to the fabricator environment through automation such as the tool pod tool chassis examples may create an ability to create factories with many tools in a cognitive system. There may be hundreds, thousands, tens of thousands to hundreds of thousands of tools in a cognitive factory. In some models of such systems the nature of interactions may increase by some mathematical power function related to the number of nodes. Complex cognitive systems may provide the necessary formalisms for such a factory to function. The various flows of information may relate to sensing and operational data from the various tools, from automated handling systems, from processing flow and logistics related systems, from material and product testing systems and environmental sensing and control systems for the fabricator as a whole.

Referring to FIG. 13C an even more complex system may be defined when fabricators of various size and complexity, which may be cognitive factories as well interact cognitively. A dedicated cognitive node 1360 may coordinate or provide dedicated support to a combinatorial cognitive system. There may be individual factories such as factory 1350, factory 1352, factory 1354, factory 1356, and factor 1358. These factories may have cognitive systems such as systems 1351, systems 1353, systems 1355, systems 1357 and systems 1359. As discussed before the complex combinatorial cognitive system may have other interactions to the environment of the system or external to the system, stakeholders, and the like.

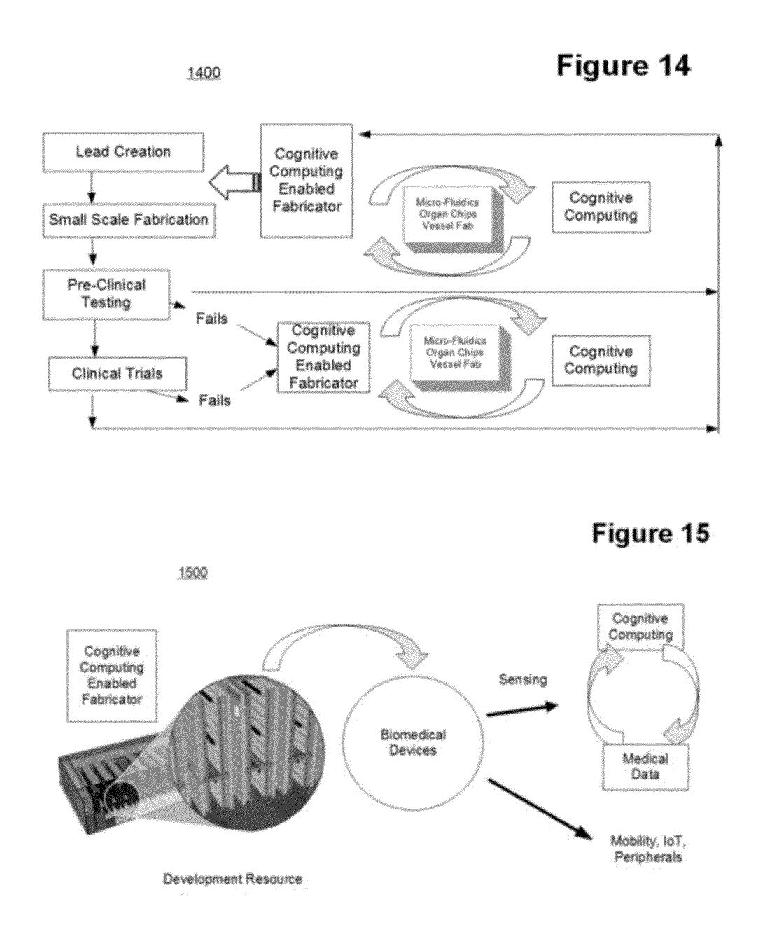

Proceeding to FIG. 14, an exemplary cognitively engaged product development flow 1400 may be illustrated for the example of pharmaceutical developments. In the exemplary flow, a cognitive system may be useful for the process of developing insight and leads for targets of research and development. A flow may ensue involving small scale fabrication. The system and infrastructure may be heavily connected from a sensing and operational data perspective to the cognitive system. Cognitive factories of small volume scale as have been discussed may be used to fabricate the pharmaceutical lead or materials related to the lead in various ways. In some examples, more conventional vessel type fabrication may be performed in interaction with the cognitive system. In other examples novel manners of production including microfluidics or lab on chip protocols may be performed. Microfluidics, and versions called Organ chips may be used in the fabricator to perform analysis of various kinds. Organ chips are known in the art of microfluidics and have portions that simulate the function of human organs. Other metrology equipment may also be located in the facility in some examples. In other examples, measurements may be performed after a sample leaves the fabricator. In some examples, the external equipment may nevertheless be connected within the cognitive system space.

In more advanced portions of the flow, the leads may be refined and subjected to further testing. In some examples the further testing may occur within the cognitive factory paradigm. In some examples such as trials in animals or in humans the testing may be connected within the cognitive system. In some cases, such trials have failures. There may be signals that exist from the information constructs that reside or are generated within the cognitive factory environment which may have information related to the failure that may be recognized at the cognitive level. In other examples, further experiments and tests of various kinds may be performed within the cognitive factory to gain understanding of the cause for failure. In some cases, there may be ability for the cognitive system to understand subpopulation aspects within the trial population where a positive result for the lead may actual be present. In other examples, experiments performed in the cognitive fabricator system may elucidate variations to act as further leads and the process may restart.

Referring to FIG. 15, a cognitive factory system 1500 may have desirable aspects for the production of biomedical devices of various kinds. The flexible factory systems as have been described allow for extremely economical setup of new dedicated manufacturing systems that are ideal for research and development activities and also scale to large manufacturing needs. The cognitive aspects may allow for sophisticated control aspects as well as providing the design infrastructure for abundant variations on prototypical designs. The resulting products may have inherent interactions with the cognitive systems as they perform their intended product functions which may include internet connected sensing operations.

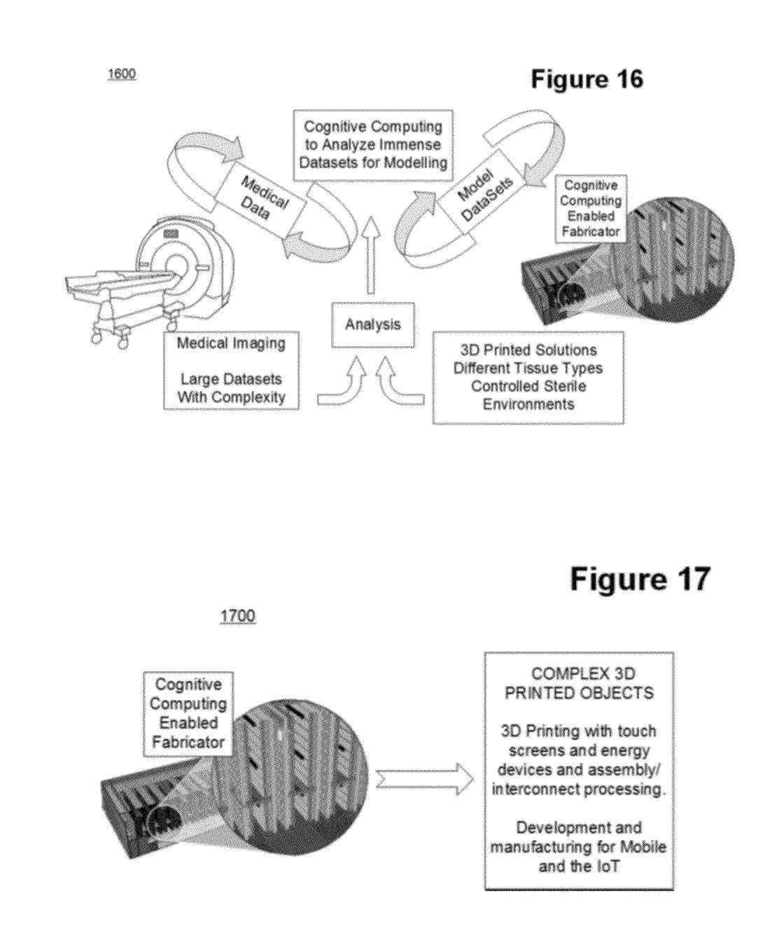

Referring to FIG. 16, a cognitive factory system 1600 may have desirable aspects for the production of human organs. The cognitive computing systems may have an invaluable capability in combination with medical imaging techniques and vast medical databases related to health metrics and medical data systems to recognize tissue types and structural aspects of a patents existing organ system. For example an MRI/CT system may have the ability of extracting enough information to model the structure and interaction of structures within an organ targeted for replacement. As a non-limiting example a heart organ may be illustrated. The heart may be a complex three dimensional combination of muscle tissue, connective tissue, vein and artery structures, nerve structures, fat structures and other tissues. The cognitive system may use medical imaging system data, historical datasets and the like to generate a model of the organ that may be a complete match to an existing organ. In some examples the cognitive system may take the analysis to a next step, and recognize inherent defectiveness in the existing organ and model. In some examples in concert with human interaction changes may be identified and made to the model. In other examples the cognitive system may make the changes while reporting on the changes. The resulting model may then be broken down into control streams for various processing tools to create the organ. In a non-limiting example three dimensional printing equipment may process the different tissue types in a three dimensional production within a cognitive factory environment. The resulting organ may itself be subjected to analysis of various kinds and as necessary new models may be created and fabricated.

Referring to FIG. 17, a cognitive factory system 1700 may be used to create complex objects that may related to the mobile space and the internet of things. A combination of some or all of the following processing modules may be used. The four fundamental modules may include semiconductor production, energy device production, optoelectronics production, and assembly and test processing. A cognitive computing system may provide sophisticated modelling capabilities as well as sophisticated analysis of test protocols that may be invaluable to the creation of numerous and varied prototypes of products relating to the internet of things and mobile devices. In some examples, the unique processing environment as described herein will enable the creation of devices uniquely related to the non-powered applications for the internet of things.

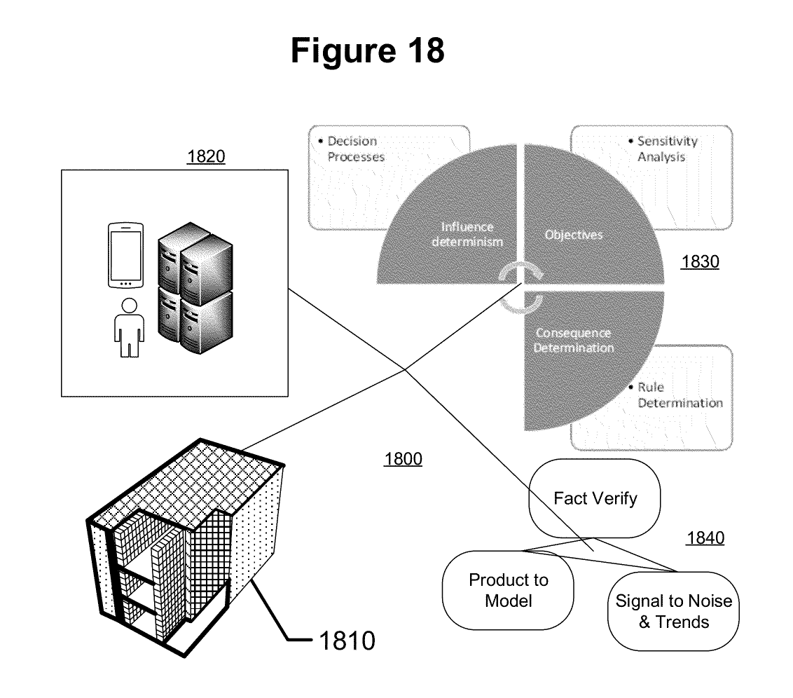

Referring to FIG. 18, a high level summary of aspects that may be involved in the function of a cognitive factory system may be outlined. In some examples, a cognitive node 1800 may interact with a fabricator element 1810 and have various external and internal data and communication sources 1820. The cognitive system may execute computer code that may be designed to process, analyze, detect trends and perform other cognitive functions. The systems may have functionalities 1830 that evaluate, use or produce aspects of determining decision processes, sensitivity analysis, rule determination and the like, In addition there may be determination of consequences, objectives and influence aspects. Control aspects 1840 of the system may operate in feedback nodes to perform such functionalities as verifying facts, evaluating product results to modelled results, evaluating what results are inherently related to real signals and which are noise as well as detecting trends.

The cognitive system may perform the exemplary functions and have the exemplary structure or may have other structure and functionalities. In general the cognitive system may operate to render new needs and problems accessible to computing. It may typically assemble data from various sources including databases on servers and other computer systems, databases or streamed data from sensors, networks of sensors, networks of computers coupled to sensors and networks of cogs coupled to sensors. In some examples the sensors are capable of transforming and environmental state or variable into a digital data value or message. The cognitive system may be capable of function in complex situations which may be uncertain or difficult to understand. The cognitive infrastructure may function well with high levels of information and high levels of dynamism where data and information may not have clear non-conflicting characteristics. The cognitive system may function to solve questions and problems and then learn from these solutions or answers in manners that support future function. The cognitive systems may be able to form contextual understanding of the physical trends in processing, tooling, and the complex interaction of the numerous examples of variability that may occur in complex processing. Cognitive systems may run abundant simulations to find trends and other important aspects. The cognitive systems may be interactive with various types of nodes including people, tools, data systems and the like. The cognitive systems may be adaptive, iterative, stateful and contextual. In some cases these capabilities may replace or supplement the definitions related to Cognitive computes as defined below. An exemplary cognitive computing system may be found in reference to the IBM “Watson” system definition and capabilities currently operant.

Some examples of the present invention which relate to the specific application of semiconductor fabrication have been described in order to better demonstrate various useful aspects of the invention. However, such exemplary descriptions are not meant to limit the application of the inventive concepts described herein in any way. Examples may therefore include, for example, applications in research and generation of: pharmaceutical products, nanostructure products and other applications which benefit from the availability of cleanspace and multiple processing tools.

### Glossary of Selected Terms

Air receiving wall: a boundary wall of a cleanspace that receives air flow from the cleanspace.
Air source wall: a boundary wall of a cleanspace that is a source of clean air flow into the cleanspace.
Annular: The space defined by the bounding of an area between two closed shapes one of which is internal to the other.
Automation: The techniques and equipment used to achieve automatic operation, control or transportation.
Ballroom: A large open cleanroom space devoid in large part of support beams and walls wherein tools, equipment, operators and production materials reside.
Batches: A collection of multiple workproducts to be handled or processed together as an entity
Boundaries: A border or limit between two distinct spaces—in most cases herein as between two regions with different air particulate cleanliness levels.
Circular: A shape that is or nearly approximates a circle.
Clean: A state of being free from dirt, stain, or impurities—in most cases herein referring to the state of low airborne levels of particulate matter and gaseous forms of contamination.
Cleanspace: A volume of air, separated by boundaries from ambient air spaces, that is clean.
Cleanspace Fabricator: A fabricator where the processing of workproducts occurs in a cleanspace that is not a typical cleanroom, in many cases because there is not a floor and ceiling within the primary cleanspace immediately above and below each tool body's level; before a next tool body level is reached either directly above or below the first tool body.
Cleanspace, Primary: A cleanspace whose function, perhaps among other functions, is the transport of jobs between tools.
Cleanspace, Secondary: A cleanspace in which jobs are not transported but which exists for other functions, for example as where tool bodies may be located.
Cleanroom: A cleanspace where the boundaries are formed into the typical aspects of a room, with walls, a ceiling and a floor.
Cleanroom Fabricator: A fabricator where the primary movement of substrates from tool to tool occurs in a cleanroom environment; typically having the characteristics of a single level, where the majority of the tools are not located on the periphery.
Cognitive Computing: The use of computers in Cognitive Science. Herein, the ability of computers to recognize complex patterns in datasets and communicate answers to queries related to the datasets. The complex reasoning capabilities are similar or based upon the study of intelligence and can be used to generate models from the dataset particularly in response to user commands. In some examples the complexity is beyond the scope of human calculation abilities.
Cognitive Science: The scientific study of intelligence (as distinct from the study of the brain), including artificial intelligence and some branches of computer science. See ARTIFICIAL INTELLIGENCE.
Core: A segmented region of a standard cleanroom that is maintained at a different clean level. A typical use of a core is for locating the processing tools.
Ducting: Enclosed passages or channels for conveying a substance, especially a liquid or gas—typically herein for the conveyance of air.
Envelope: An enclosing structure typically forming an outer boundary of a cleanspace.
Fab (or fabricator): An entity made up of tools, facilities and a cleanspace that is used to process workproduct.
Fit up: The process of installing into a new clean room the processing tools and automation it is designed to contain.
Flange: A protruding rim, edge, rib, or collar, used to strengthen an object, hold it in place, or attach it to another object. Typically herein, also to seal the region around the attachment.
Folding: A process of adding or changing curvature.
HEPA: An acronym standing for high-efficiency particulate air. Used to define the type of filtration systems used to clean air.
Horizontal: A direction that is, or is close to being, perpendicular to the direction of gravitational force.
Job: A collection of workproducts or a single workproduct that is identified as a processing unit in a fab. This unit being relevant to transportation from one processing tool to another.
Laminar Flow: When a fluid flows in parallel layers as can be the case in an ideal flow of cleanroom or cleanspace air. If a significant portion of the volume has such a characteristic, even though some portions may be turbulent due to physical obstructions or other reasons, then the flow can be characterized as in a laminar flow regime or as laminar.
Logistics: A name for the general steps involved in transporting a job from one processing step to the next. Logistics can also encompass defining the correct tooling to perform a processing step and the scheduling of a processing step.
Matrix: An essentially planar orientation, in some cases for example of tool bodies, where elements are located at discrete intervals along two axes.
Multifaced: A shape having multiple faces or edges.
Nonsegmented Space: A space enclosed within a continuous external boundary, where any point on the external boundary can be connected by a straight line to any other point on the external boundary and such connecting line would not need to cross the external boundary defining the space.
Perforated: Having holes or penetrations through a surface region. Herein, said penetrations allowing air to flow through the surface.
Peripheral: Of, or relating to, a periphery.
Periphery: With respect to a cleanspace, refers to a location that is on or near a boundary wall of such cleanspace. A tool located at the periphery of a primary cleanspace can have its body at any one of the following three positions relative to a boundary wall of the primary cleanspace: (i) all of the body can be located on the side of the boundary wall that is outside the primary cleanspace, (ii) the tool body can intersect the boundary wall or (iii) all of the tool body can be located on the side of the boundary wall that is inside the primary cleanspace. For all three of these positions, the tool's port is inside the primary cleanspace. For positions (i) or (iii), the tool body is adjacent to, or near, the boundary wall, with nearness being a term relative to the overall dimensions of the primary cleanspace.
Planar: Having a shape approximating the characteristics of a plane.
Plane: A surface containing all the straight lines that connect any two points on it.
Pod: A container separating an interior space comprising one or more tooling components from an exterior space.
Polygonal: Having the shape of a closed figure bounded by three or more line segments Process: A series of operations performed in the making or treatment of a workproduct.
Robot: A machine or device that operates automatically or by remote control, whose function is typically to perform the operations that move a job between tools, or that handle workproduct within a tool.
Round: Any closed shape of continuous curvature.
Substrates: A body or base layer, forming a product, that supports itself and the result of processes performed on it. A substrate is a type of workproduct.
Tool: A manufacturing entity designed to perform a processing step or multiple different processing steps. A tool can have the capability of interfacing with automation for handling jobs of substrates. A tool can also have single or multiple integrated chambers or processing regions. A tool can interface to facilities support as necessary and can incorporate the necessary systems for controlling its processes.
Tool Body: That portion of a tool other than the portion forming its port.
Tool Port: That portion of a tool forming a point of exit or entry for jobs to be processed by the tool. Thus the port provides an interface to any job-handling automation of the tool.
Tubular: Having a shape that can be described as any closed figure projected along its perpendicular and hollowed out to some extent.
Unidirectional: Describing a flow which has a tendency to proceed generally along a particular direction albeit not exclusively in a straight path. In clean air flow, the unidirectional characteristic is important to ensuring particulate matter is moved out of the cleanspace.
Unobstructed removability: refers to geometric properties, of fabs constructed in accordance with the present invention that provide for a relatively unobstructed path by which a tool can be removed or installed.
Utilities: A broad term covering the entities created or used to support fabrication environments or their tooling, but not the processing tooling or processing space itself. This includes electricity, gasses, air flows, chemicals (and other bulk materials) and environmental controls (e.g., temperature).
Vertical: A direction that is, or is close to being, parallel to the direction of gravitational force.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method of producing products; said method comprising:
fixing two or more processing tools into position in a fab wherein the two or more processing tools at least a vertical dimension relative to each other, wherein the two or more processing tools are peripherally located with respect to a fab workproduct transportation region comprising a first boundary and a second boundary, and wherein each of the processing tools is capable of independent operation, and wherein each of the processing tools is removable in an unobstructed fashion relative to other processing tools;
connecting the fab and the two or more processing tools to a cognitive computing system;
removing a workproduct from a workproduct carrier into a first tool port;
performing a first process on the workproduct in the first tool;
containing the workproduct in the workproduct carrier subsequent to the performance of the first process;
transporting the workproduct carrier to a second tool port within the fab workproduct transportation region;
exchanging a sensor information and a logistic information from the second tool to the cognitive computing system;
removing the workproduct from the workproduct carrier into the second tool port;
and performing a second process on the workproduct in the second tool.

2. The method of claim 1 wherein the fab workproduct transportation region is a cleanspace.

3. The method of claim 2 wherein the workproduct is a pharmaceutical.

4. The method of claim 2 wherein the workproduct is a biomedical device.

5. The method of claim 2 wherein the workproduct is a human organ.

6. The method of claim 2 wherein the workproduct is a mobile electronic device.

7. The method of claim 2 wherein the workproduct is an internet of things device.

8. The method of claim 2 wherein the second tool performs a microfluidic processing step.

9. The method of claim 2 wherein the workproduct is a microfluidic device.

10. The method of claim 2 wherein the workproduct is an organ chip.

11. The method of claim 2 wherein the workproduct is contained in a vessel.

12. The method of claim 2 additionally comprising:
initiating a communication protocol between a user and the cognitive computing system.

13. The method of claim 12 wherein the communication protocol involves a query answer protocol.

14. The method of claim 1 wherein the second tool performs a 3d printing operation.

15. A product fab comprising:
a support structure for fixing in place two or more workproduct processing tools into position in at least a vertical dimension relative to each other, wherein the two or more workproduct processing tools are peripherally located with respect to a fabricator workproduct transportation region comprising a first boundary and a second boundary, and wherein each of the processing tools is capable of independent operation and removable in a discrete fashion relative to other processing tools;
connections for connecting facility lines to each of the two or more workproduct processing tools;
robotic automation for transporting work product between the two or more workproduct processing tools; and
a cognitive computing system.

16. The product fab of claim 15 wherein the workproduct transportation region is a cleanspace.

17. The product fab of claim 16 wherein the cognitive computing system is capable of executing a sequential Markov decision process in response to data sensed in the two or more workproduct processing tools.

18. The product fab of claim 16 additionally comprising a partially processed human organ.

19. The product fab of claim 16 wherein there are more than 100 processing tools in the fab that are in communication with the cognitive computing system.

20. The product fab of claim 16 where there are more than 10,000 processing tools in the fab that are in communication with the cognitive computing system.
